(19) United States
(12) Patent Application Publication
(10) Pub. No.: US 2016/0163170 A1
(43) Pub. Date: Jun. 9, 2016

(54) RFID warning intel signal-grit system

(71) Applicant: RFID Associates, Trustee for RFID warning intel signal-grit system CRT Trust, Manassas, VA (US)

(72) Inventor: S. Mill Calvert, Manassas, VA (US)

(73) Assignee: RFID Associates Trustee for RFID warning intel signal-grit system CRT Trust

(21) Appl. No.: 14/558,373

(22) Filed: Dec. 2, 2014

(51) Int. Cl. G08B 13/22; G06K 19/07; G08B 25/10

(52) U.S. Cl. CPC G08B 13/22; G08B 25/10; G06K 19/0723

(57) ABSTRACT

A system for remote detection of troop movement uses granular RFID tags that can respond with a signal when altered by that movement. The system includes a scanner, multiple granular-size radio-frequency identification tags, a conductor and a remote station. Each of the RFID tags includes a RFID chip that generates a responding signal to an interrogating signal from the scanner. Each RFID tag has an antenna so that the RFID tag can transmit the responding signal, but can do so only after the antenna is activated. A conductor is formed so as to short circuit the antenna and preclude the antenna from activating and transmitting the responding signal. The conductor breaks, and activates the antenna when the conductor is stepped on by a person walking on the RFID tag. The system includes a remote station configured to receive the responding signal retransmitted by the scanner.

### TECHNICAL FIELD

In the field of sensors and registers, a system for detection of movement over the ground at a remote location includes the use of granular radio-frequency identification (RFID) tags modified to activate when stepped on.

### BACKGROUND ART

The typical RFID tag, also called a transponder, enables storage of data and transmission of that stored data through an antenna. The activation of that RFID tag may be by battery, in which case it is called active RFID tag. Alternatively, activation of the RFID tag may be by the interrogating radio-frequency signal sent by a reader, also referred to herein as a scanner, that is programmed to send a specific signal frequency. A RFID tag that is energized by the interrogating radio-frequency signal is call a passive RFID tag. In either case of a passive or active RFID tag, the RFID tag has an antenna that enables it to receive and respond to radio frequency queries from a RFID scanner.

The typical RFID tag contains a transponder with a digital memory chip, also referred to a Read Only Memory, that stores data. When the RFID scanner emits an activation signal that activates the RFID tag, the RFID tag responds with a signal that includes the data. Typically, the RFID tag is always activated and awaiting the specific signal frequency to thereafter send a responding signal. For the present application, the RFID tag is normally inactive and unable to respond to the RFID scanner until it is made active by mechanically breaking a short circuit acting on the antenna.

A primary application of this technology involves military intelligence on troop movements gained by automation and without reliance on field operatives. Knowing the specific location of both enemy forces and your own forces has always been one of the most important factors throughout the long history of the art of warfare. This valuable intelligence enables military planners and strategists to map out their plan to try and defeat the enemy and keep their own troops safe.

In the past, sentries, spies and informants were relied upon to gather intelligence as to where troops were located and to have advance warning if the troops were moving toward specific military locations. It was often a difficult process to set up this network of spies and informants to gain close enough access to the enemy to monitor their movements. The quality of this intelligence was often of questionable value because you never knew who may have been a double agent or if they were just making up the intelligence to grab the payoff.

### SUMMARY OF INVENTION

A system for remote detection of troop movement uses granular RFID tags that can respond with a signal when altered by that movement. The system includes a scanner, multiple granular-size radio-frequency identification tags, a conductor and a remote station. The scanner is an RFID reader that has a radio-frequency transmitter, a battery, and a circuit to transmit an interrogating signal to the RFID tags and retransmit a responding signal sent by the RFID tags and received by the scanner.

Each of the RFID tags includes a RFID chip that generates the responding signal. The RFID chip has a maximum dimension in any direction that is no larger than 6 millimeters. Each RFID tag has an antenna connected to a RFID chip, wherein the antenna: energizes the RFID chip when it receives the interrogating signal from the scanner. The RFID tag can transmit the responding signal only after the antenna is activated.

A conductor is formed so as to short circuit the antenna and preclude the antenna from activating and transmitting the responding signal. The conductor is made of a frangible material that breaks, disconnects the short circuit and activates the antenna when the conductor is stepped on by a person walking on the RFID tag. The system includes a remote station configured to receive the responding signal retransmitted by the scanner.

### TECHNICAL PROBLEM

It would be of great benefit if there were technology that could be relied upon to gather intelligence on movement occurring over key pathways in a military operation. The technology could be deployed in the field as needed and would not be subject to the vagaries of whether or not an overhead observation satellite was in place and available. In addition a field deployment of troops could utilize easily implemented technology to avoid having to find and rely on human intelligence.

Instead of having to rely on the imperfect nature of human beings, If technology could send warnings and locations of troop movement, military command would have greater confidence in knowing that this information is immediate, current and not compromised by an intelligence source that may have been paid off or compromised.

### SOLUTION TO PROBLEM

The problem of dependable intelligence and warnings of troop movements and locations has now been solved with the invention of the RFID Warning Intel Signal Grit System. This new technology gives military planners a source of intelligence that they can rely upon.

The RFID Warning Intel Signal Grit System works by having small RFID devices that send out specific frequency signals. These small or granular RFID devices are coated with a signal blocking conductor that short circuits the antenna and prevents a responding signal from broadcasting out from the RFID tag. The conductor is made of a frangible material so that it easily breaks when walked on. Once broken, the RFID tag can send a responding signal to the scanner.

The granular RFID tags, also referred to as RFID grit, can be spread like grass seed at specific locations. If anyone walks over this area or military vehicles pass by, the conductor will fracture and the antenna will become functional. The RFID tag will then transmit responding signal to be read by the RFID scanner.

The RFID scanner is a small device that would be hidden in a location within the RFID tag's signal area, so that it can receive the responding signal and broadcast it to a remote location. The RFID scanner is thus a receiver/signal re-broadcaster device. It could send the signal to a camp a few miles away or could send it to an Earth-orbiting satellite, much like a cellular telephone.

The benefit is that the movement intelligence can be received anywhere in the world. For instance, RFID tags could be sprinkled on the ground on numerous mountain trails and paths in a country like Afghanistan, and as enemy troops move across this area in the middle of the night, a military intelligence operator could be sitting in a control room halfway around the world and receive the satellite intelligence signals so he can order air strikes.

The RFID tags could be sprinkled in front of the tires of enemy aircraft that are parked on an aircraft carrier or at an airport. When the enemy planes begin to move, the intelligence is immediately sent. It would be easy to use RFID Warning Intel Signal Grit System to keep track of groups like ISIS and find out where they go to hide at night.

Another use of RFID Warning Intel Signal Grit System could be for a soldier that was captured by the enemy to be able to send the current location of where he is being held. The RFID scanner, i.e. the receiver/re-broadcaster device and a single RFID module can be small enough to be hidden on a soldier or inserted into parts of the human body to conceal it. Pressure on a particular area could break the conductor and activate the RFID tag.

There could even be units the size of a capsule that the soldier can swallow so even an extensive strip search would reveal nothing. The capsule would pass through the bowel system and activated afterwards. The enemy could be holding the soldier for an internet beheading and because of the RFID Warning Intel Signal Grit System, one dark night all of the enemy will be lying dead on the floor from double bullet holes through their heads, special delivery by a SEAL team. There is really no limit to the variety of locations that RFID Warning Intel Signal Grit System could be deployed.

### ADVANTAGEOUS EFFECTS OF INVENTION

RFID Warning Intel Signal Grit System is a needed and dependable new military technology that will help to win wars and conflicts and return our troops home safe and healthy.

### BRIEF DESCRIPTION OF DRAWINGS

The drawings illustrate preferred embodiments of the system for remote detection of movement over granular radio-frequency identification (RFID) tags. The reference numbers in the drawings are used consistently throughout. New reference numbers in FIG. 2 are given the 200 series numbers.

FIG. 1 is an illustration of the components of a preferred embodiment of the system for remote detection of movement over granular RFID tags.

FIG. 2 is a perspective view of a soldier distributing granular RFID tags over a trail.

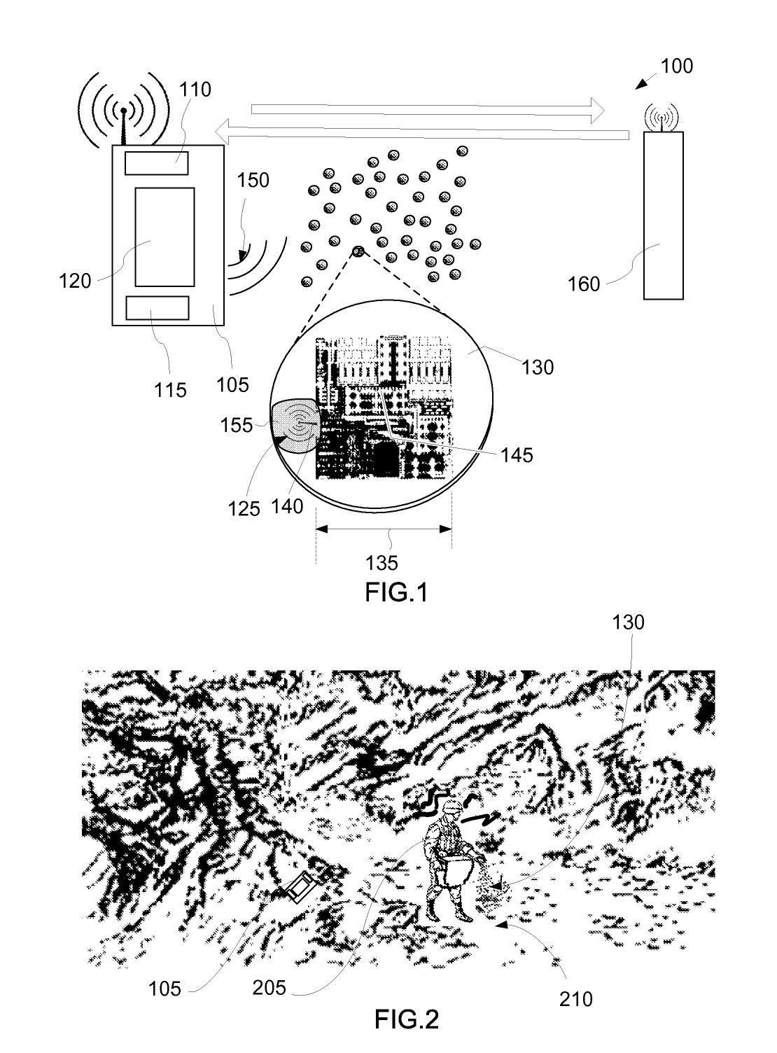

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

A system (100) is disclosed for the remote detection of movement, especially troop or equipment movement over a patch of earth. The system (100) employs granular RFID tags, or simply granular tags. The granular tags are preferably passive RFID tags that are structured so that they can transmit a responding signal (125) only after being altered by that movement. When the granular tags are unaltered, transmission of a responding signal is precluded.

The system (100) includes: a scanner (105); more than one radio-frequency identification tag (130); a conductor (155); and a remote station (160).

The scanner (105) includes the components of an RFID reader capable of energizing an RFID chip by sending a radio-frequency inquiring signal and receiving and reading any responding signal (125) from an RFID chip. Preferably, the scanner (105) has a control circuit that periodically sends a radio-frequency inquiring signal to determine if any nearby RFID chips are sending a responding signal (125). Preferably, the RFID chips and the scanner are located nearby each other, such as within 10 to 60 meters of each other. Such distance is dependent upon the ability of the RFID chips to send a signal and the ability of the scanner to sense that signal. Active RFID chips with a battery can send the longest distances.

The scanner (105) includes a radio-frequency transmitter (110), which is typically a microwave transmitter, also known as an ultra-high frequency transmitter. An example of a commercial RFID chip transmitting frequency is 2.45 gigahertz (GHz). Another example of a commercial RFID chip transmitting frequency is 13.56 megahertz.

The scanner (105) includes a battery (115) that powers the scanner (105) and its transmitting and receiving components.

The scanner (105) includes a circuit (120) to retransmit a responding signal (125) received by the scanner (105).

More than one radio-frequency identification tag (130) means that there is a plurality of radio-frequency identification tags in the system (100): preferably hundreds to thousands of such tags in an operational system. Each radio-frequency identification tag (130) in the plurality of radio-frequency identification tags includes a radio-frequency identification chip (145) that generates the responding signal. The radio-frequency identification chip (145) has a maximum dimension (135) in any direction that is no larger than 6 millimeters, preferably no larger than about 0.4 millimeters square and less in thickness.

Each radio-frequency identification tag (130) in the plurality of radio-frequency identification tags is preferably small enough so that when the plurality of radio-frequency identification tags is seeded on a trail (210) atop the ground, they go virtually unnoticed by anyone walking on them.

The radio-frequency identification tag (130) is essentially sized to fit the radio-frequency identification chip (145). In practice, the radio-frequency identification tag (130) is virtually the same size as the radio-frequency identification chip (145), since the antenna (140) is so small or thin as to be unnoticeable or is integrated therein to be an insubstantial addition to the overall size of the radio-frequency identification chip (145).

For example, a commercial RFID chip is accessible and wireless 0.4 millimeters on a side and thin enough to be embedded in paper, which is virtually invisible at the distance of a walking person's eyes. This exemplary RFID chip employs Read-Only-Memory (ROM) to hold data that is transmitted in response to an inquiring signal (150) from a scanner (105). Despite its diminutive size, the exemplary commercial RFID chip integrates a 2.45 GHz high-frequency analog circuit and a 128-bit ROM in an area equal to 0.16 square millimeters. While this size chip is small, there are commercially available chips sixty times smaller and are sometimes referred to as “powder chips.” Typically, however, the smallest such RFID chips also have to be closer to the scanner (105) in order for the responding signal (125) to be detected. Thus, these powder chips would require a longer attached wire antenna for use in the system (100). Such longer wires for the antenna are acceptable, but it is preferred that they are used when the wire is thin enough to go unobserved when deployed on the ground.

For most applications, it is preferably that each radio-frequency identification chip (145) in the plurality of radio-frequency identification chips have a maximum dimension (135) in any direction that is not greater than, that is no larger than, 6 millimeters. This means that any of the dimensions involving length, width, or thickness are preferably less than 6 millimeters.

Each radio-frequency identification tag (130) includes an antenna (140) connected to a radio-frequency identification chip (145). The antenna (140) energizes the radio-frequency identification chip (145) when it receives the inquiring signal (150) from the scanner; and can transmit the responding signal (125) when the antenna (140) is activated. The antenna (140) starts out in an inactivated state so that it cannot transmit a responding signal (125).

The conductor (155) is formed so as to short circuit the antenna (140). Preferably the conductor creates short circuit across antenna leads at its connection to the radio-frequency identification chip (145). The short circuit does not allow the antenna (140) to be energized by the scanner (105), which is the method used in passive RFID tag technologies to power the radio-frequency identification chip (145).

The conductor (155) and thus the short circuit precludes the antenna (140) from activating and transmitting the responding signal (125). The architecture of the conductor is such that it cracks apart when stepped on. The conductor (155) may be a brittle paint-like coating or it may have a structure promoting its breaking. For example, the conductor (155) may be raised from the surface of the radio-frequency identification tag (130), such as for example in a filamentary arch, to make it vulnerable to rupture when pressure is applied to it. Alternatively, it may be a metal-conductor lined or painted glass that holds the entire radio-frequency identification tag (130), but that shorts out the antenna (140) until the glass is broken. A third example is a metal-conductor lined glass enclosure that protrudes or arches up and when the glass breaks, electrical continuity is lost thereby activating the antenna (140). The conductor (155) is preferably made of a frangible material that breaks, disconnects the short circuit and activates the antenna (140) when the conductor (155) is stepped on by a person (205) walking on the radio-frequency identification tag (130).

The remote station (160) is able to receive the responding signal retransmitted by the scanner (105). The remote station (160) may be a repeater station, or a command center a few miles from the monitored area. Alternatively, the remote station (160) may be a satellite with signal receiving equipment. The concept of it being remote is that it may be tens of miles away in a central command outpost for a war time operation. Alternatively, it may be thousands of miles away in contact through one or more satellites and far from the actual theater of operations.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the signal and tracking industry.

What is claimed is:

1. A system for remote detection of troop movement using granular radio-frequency identification tags that can respond with a signal when altered by that movement, the system comprising:
a scanner comprising a radio-frequency transmitter, a battery, and a circuit to transmit an inquiring signal and retransmit a responding signal received by the scanner;
a plurality of radio-frequency identification tags, wherein each radio-frequency identification tag in the plurality of radio-frequency identification tags comprises:
a radio-frequency identification chip that generates the responding signal and has a maximum dimension in any direction that is no larger than 6 millimeters,
an antenna connected to a radio-frequency identification chip, wherein the antenna:
energizes the radio-frequency identification chip when it receives the inquiring signal from the scanner; and
can transmit the responding signal when the antenna is activated;
a conductor formed so as to short circuit the antenna and preclude the antenna from activating and transmitting the responding signal, the conductor comprising a frangible material that breaks, disconnects the short circuit and activates the antenna when the conductor is stepped on by a person walking on the radio-frequency identification tag; and,
a remote station configured to receive the responding signal retransmitted by the scanner.
